(19) United States
(12) Patent Application Publication
(10) Pub. No.: US 2002/0035702 A1
(43) Pub. Date: Mar. 21, 2002

(54) Method for automatically wake up a computer system to receive message transmitted via the communication protocol and to make the computer system enter into the suspend mode

(76) Inventors: Su-Fang Chu, Taipei (TW); Fu-An Chuang, Taipei (TW); Chia-Yu Chang, Taipei (TW)

Correspondence Address: RABIN & CHAMPAGNE, PC, 1101 14TH STREET, NW, SUITE 500, WASHINGTON, DC, 20005, US

(21) Appl. No.: 09/783,012

(22) Filed: Feb. 15, 2001

(30) Foreign Application Priority Data
Sep. 21, 2000 (TW) 89119537

(51) Int. Cl. G06F 1/26; G06F 1/28; G06F 1/30

(52) U.S. Cl. 713/323

(57) ABSTRACT

A method for allowing to automatically wake up a computer system to receive messages transmitted by a communication apparatus via a communication protocol and then to make the computer system enter into the suspend mode. When the computer system wakes up by the incoming message transmitted via the communication protocol, a Fax/Answering machine function is triggered to receive the Fax/voice message. After the incoming message is completely transmitted, the system suspend function is triggered to make the computer system enter into the suspend mode immediately without waiting for a period of time, therefore, the objective of saving electric power is achieved adequately.

### BACKGROUND OF THE INVENTION

This application incorporates by reference Taiwanese application Serial No. 089119537, Filed Sep. 21, 2000.

1. Field of the Invention

The invention relates in general to the method for computer system to enter into the suspend mode, and more particularly to the method for computer system to enter into the suspend mode after being woken up by an incoming message via communication protocol.

2. Description of the Related Art

In the past few years, the application of computer and the related products have become very popular. Although computer brings us great convenience, it consumes large amounts of energy. With an ever-increasing awareness of environmental concerns, energy saving of computer systems is of major interest. For example, computer systems are designed automatically to enter into a suspend mode after it is not used for a period of time. In the suspend mode, the computer system only requires a small amount of energy for the Central Process Unit (CPU) and Random Access Memory (RAM), therefore, the energy required by the computer is decreased. In general, the computer system enters into the suspend mode automatically if the input apparatus such as the keyboard or mouse are not being used for a while. When the keyboard or mouse is used, the computer system wakes up automatically and enters into the working mode.

The computer system is waked up by not only the operation of input apparatus, but also by the start of Modem or local area network (wake up on Modem or LAN) which is set in the BIOS (basic input/output system). The action of the latter method is: when Modem or LAN receives an incoming message, it will send the interrupt request (IRQ) to the CPU, bringing the computer system, out of the suspend mode. Subsequently, the computer system starts to receive and deal with the incoming message such as a Fax or phone call. This provides a method to successfully receive all incoming messages without missing even the computer system is under the suspend mode.

Although the method of using Modem to wake up the computer system is very convenient, nevertheless, it is still defective. After the computer system is waken up and have dealt with the incoming message, it needs to wait for another period of time before it enters into the suspend mode, therefore, the energy is not economized adequately resulting of the waiting time.

### SUMMARY OF THE INVENTION

It is therefore an object of the invention to provide a method for allowing to automatically wake up a computer system to receive messages transmitted by a communication apparatus via a communication protocol and then to make the computer system enter into the suspend mode. Hence, the computer system can be woken up while in the suspend mode to receive Fax or voice message, and then return to the suspend mode immediately after message has been completely received.

The invention achieves the above identified objects by providing a method for allowing to automatically wake up a computer system to receive messages transmitted by a communication apparatus via a communication protocol and then to make the computer system enter into the suspend mode, the method includes: (a) if the computer system is woken up by an incoming message via the communication protocol, proceeding to step (b); otherwise, the computer system is led to a regular progress and the method ends; (b) triggering a fax/answering machine function of the computer system to receive a fax or voice message transmitted by the communication apparatus; (c) if the transmission of the incoming message terminates, proceeding to step (e); otherwise proceeding to step (d); (d) waiting for a predetermined time and proceeding to the step (c); and (e) calling a system suspend function of the computer system to make the computer system enter into the suspend mode.

According to the objective of the invention, a computer system is further provided that the computer system for allowing to be automatically waken up to receive an incoming message and then enter into the suspend mode. The computer system includes a communication apparatus and a host. The communication apparatus is for receiving the first incoming message, and also for outputting the wakening message and the second incoming message via the communication protocol. The host is for receiving the wakening message and the second incoming message to wake up the host. Subsequently, the host enters into the suspend mode after successfully receiving the second incoming message.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (prior art) illustrates a block diagram of the conventional process by which a computer system is waken up from the suspend mode;

FIG. 2 illustrates a block diagram of the computer system for allowing to be automatically waken up to receive an incoming message and then enter into the suspend mode in accordance with the invention; and

FIG. 3 is a flowchart for illustrating operation steps of FIG. 2 in accordance with the invention.

### DESCRIPTION OF THE PREFERRED EMBODIMENT

The following description is presented to enable any person skilled in the art to make and use the invention, and is provided in the context of a particular application and its requirements. Various modifications to the preferred embodiment(s) will be readily apparent to those skilled in the art, and the principles defined herein may be applied to other embodiments and applications without departing from the spirit and scope of the invention. Thus, the present invention is not intended to be limited to the embodiment(s) shown, but is to be accorded with the broadest scope consistent with the principles and features disclosed herein.

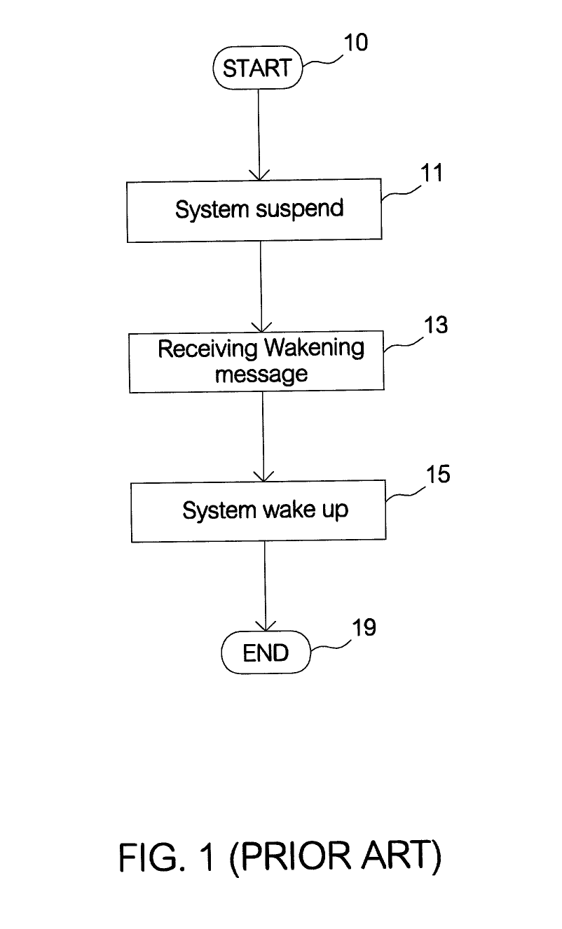

Referring to FIG. 1 (prior art), which a block diagram of the conventional process by which a computer system is waken up from the suspend mode is presented. In step 11, the computer system enters into the suspend mode after the user doesn't use the computer for a period of time. In step 13, the computer system receives a wakening message. The wakening message may be sent to the Central Process Unit (CPU) as a result of the keyboard or mouse being used. This wakening message is the interrupt request (IRQ) and the IRQ of the keyboard and mouse are 1 and 12, respectively. In addition, when a Modem apparatus receives an incoming message, an IRQ is also sent to the CPU to wake up the computer system. If the Modem apparatus is connected to the communication port 1 (COM1) or 2 (COM2) of the computer, the IRQ now is 3 or 4 which are the IRQ of the communication port. However, if the Modem apparatus, such as Modem card, is not linked to the communication port, the computer system will assign the IRQ to the Modem apparatus.

Subsequently, the computer system is waken up and enters into the regular progress (step 15). The computer system then enters into the suspend mode after it is not being used for a period of time.

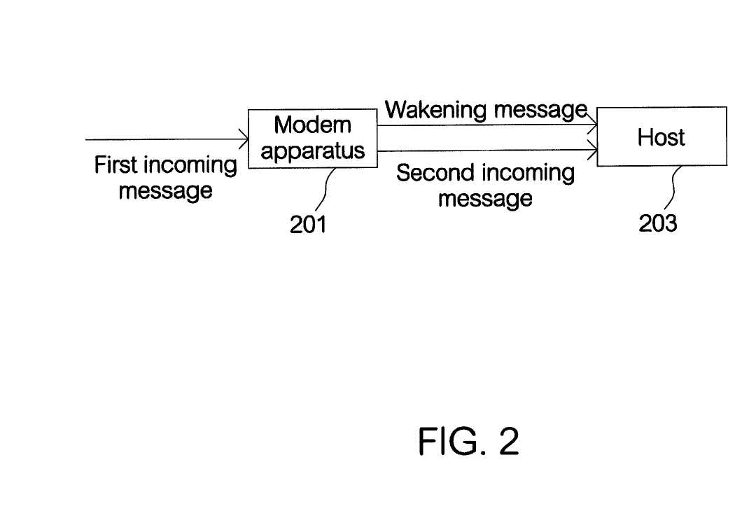

According to the invention, the operation in Step 15 is improved so that the computer system is capable of entering into the suspend mode without waiting for a period of time after completely receiving the message. Referring to FIG. 2, which a block diagram of the computer system for allowing to be automatically waken up to receive an incoming message and then enter into the suspend mode is presented. The computer system includes a Modem apparatus 201 and a host 203. The Modem apparatus 201, which is connected to the telephone line, receives the first incoming message from the telephone, and then outputs the wakening message and the second incoming message to the host 203. The wakening message wakes up the host to receive and deal with the second incoming message.

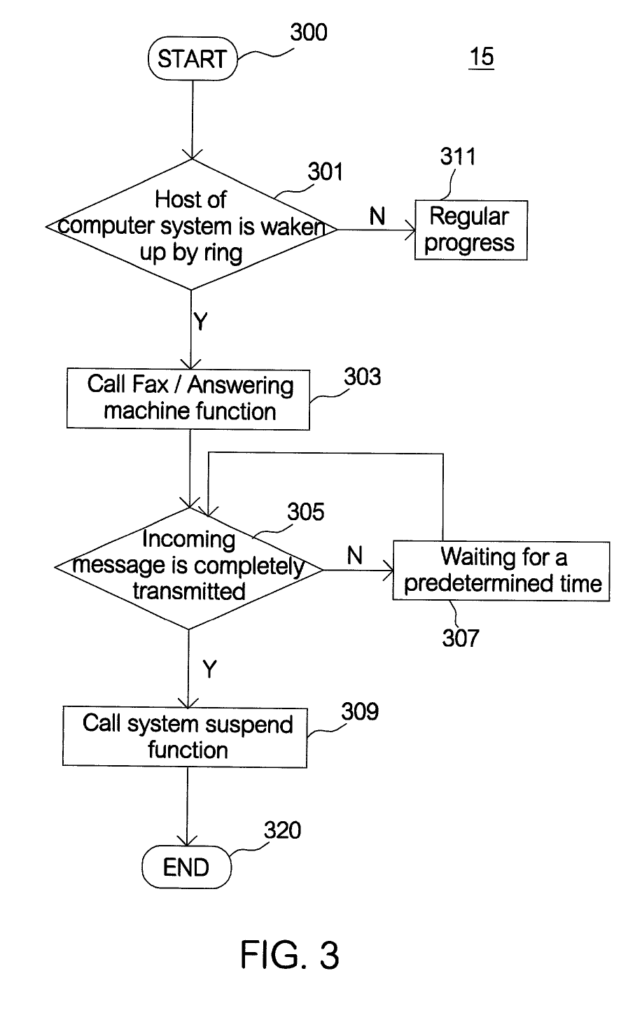

Referring to FIG. 3, which a flowchart for illustrating the operation steps of FIG. 2 is presented. Step 15 is improved by the method of the invention which is set as a background program in the computer system; when the computer system is waken up by the incoming message, the method of the invention is triggered.

In step 301 of FIG. 3, it is determined whether the host 203 of the computer system is waken up by a wakening message transmitted from the modem apparatus 201, and whether the message is the IRQ of the Modem apparatus 201. If the determination is positive (representing the computer system is waken by the wakening message from the modem apparatus 201), the Modem apparatus 201 sends the second incoming message to the host 203 and then the operation is led to step 303. If the determination is negative (representing the computer system is waken by other device or software), the operation is led to step 311 which is the regular progress.

In step 303, the Fax or Answering machine function is triggered to receive the second incoming message that is transmitted by the communication apparatus 201, and then operation is led to step 305. The second incoming message may be a Fax message or voice message.

In step 305, it is determined whether the incoming message from the modem apparatus 201 is completely transmitted. If the determination is positive, the operation is led to step 309. If the determination is negative, the operation is led to step 307.

In step 307, the operation is led to step 305 after a predetermined time which is set from 0.5 sec to 1 sec and able to be adjusted by user.

In step 309, the system suspend function is called to make the computer system enter into the suspend mode.

According to the invention, the computer system is waken up by Fax or voice message while it is in the suspend mode, and then the Fax or Answering machine function is triggered to receive the incoming message. After the message is received successfully, the computer system is able to enter into the suspend mode immediately without waiting for a period of time. Therefore, the objective of saving electric power is achieved adequately.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer system for allowing to be automatically waken up to receive an incoming message and then enter into the suspend mode, the computer system comprising:
a communication apparatus for receiving an external first incoming message, and outputting a wakening message and a second incoming message via a communication protocol; and
a host for receiving the wakening message and the second incoming message to wake up the host and entering into the suspend mode after receiving the second incoming message.

2. A method for allowing to automatically wake up a computer system to receive messages transmitted by a communication apparatus via a communication protocol and then to make the computer system enter into the suspend mode, the method comprising steps of:
(a) proceeding to step (b) if the computer system is woken up by an incoming message via the communication protocol, otherwise, the computer system is led to a regular progress and the method ends;
(b) triggering a fax/answering machine function of the computer system to receive a fax or voice message transmitted by the communication apparatus;
(c) proceeding to step (e) if the transmission of the incoming message terminates, otherwise proceeding to step (d);
(d) waiting for a predetermined time and proceeding to the step (c); and
(e) calling a system suspend function of the computer system to make the computer system enter into the suspend mode.

3. The method according to claim 2, wherein the step (a) determines whether an interrupt request (IRQ) for waking up the computer system is the IRQ of the communication apparatus.

4. The method according to claim 2, wherein the predetermined time is set from 0.5 sec to 1 sec approximately in step (d).

5. A method for allowing to automatically wake up a computer system to receive a communication message transmitted by a communication apparatus via a communication protocol and then to make the computer system enter into the suspend mode, the method comprising steps of:
triggering a receiving message function of the computer system to receive the communication message when the computer system is waken up by the communication message; and
triggering a system suspend function of the computer system to return the computer system into the suspend mode when the incoming message is completely transmitted to the communication apparatus.

6. A method for allowing to automatically wake up a computer system to receive a modem message transmitted by a Modem apparatus and then to make the computer system enter into the suspend mode, the method comprising steps of:
(a) proceeding to step (b) if the computer system is waken up by a call received by the Modem apparatus, otherwise the computer system is led to a regular progress and the method ends;
(b) triggering a Fax/Answering machine function of the computer system to receive a Fax or voice message transmitted by the Modem apparatus;
(c) proceeding to step (e) if the transmission of the modem message terminates, otherwise proceeding to step (d);
(d) waiting for a predetermined time and proceeding to step (c); and
(e) calling a system suspend function of the computer system to make the computer system return to the suspend mode.

7. The method according to claim 6, wherein the step (a) determines whether an interrupt request (IRQ) for waking up the computer system is the IRQ of the Modem apparatus.

8. The method according to claim 6, wherein the predetermined time is set from 0.5 sec to 1 sec approximately in step (d).

9. The method according to claim 6, wherein the Modem apparatus is a Modem.

10. The method according to claim 9, wherein the Modem is connected to a communication port of the computer system.

11. The method according to claim 6, wherein the Modem apparatus is a Modem card.

12. A method for allowing to automatically wake up a computer system to receive an incoming message transmitted by a Modem apparatus and then to make the computer system enter into the suspend mode, the method comprising steps of:
triggering a Fax/Answering machine function of the computer system to receive a Fax or voice message transmitted by the Modem apparatus when the computer system is waken up by a call received by the Modem apparatus; and
triggering a system suspend function of the computer system to return the computer system into the suspend mode when the Modem apparatus stops to transmit the Fax or voice message.

13. A method for allowing to automatically wake up a computer system to receive a Modem message transmitted by a Modem apparatus and then to make the computer system enter into the suspend mode, the method comprising steps of:
triggering a modem message receiving function of the computer system to receive the modem message when the computer system is waken up by a call received by the Modem apparatus; and
triggering a system suspend function of the computer system to return the computer system into the suspend mode when the Modem apparatus stops to transmit the Modem message.

14. The method according to claim 13, wherein the Modem message is a Fax message and the modem message receiving function is a Fax receiving function for receiving the Fax message.

15. The method according to claim 13, wherein the Modem message is a voice message and the modem message receiving function is a voice message receiving function for receiving and recording the voice message.

16. A computer system for allowing to be automatically waken up to receive an incoming message and then enter into the suspend mode, the computer system comprising:
a Modem apparatus for receiving an external first incoming message, and outputting a wakening message and a second incoming message; and
a host for receiving the wakening message and the second incoming message to wake up the host and entering into the suspend mode after receiving the second incoming message.

17. A system for allowing to be automatically waken up to receive an incoming message and then enter into the suspend mode, the system comprising:
an incoming message receiving apparatus for receiving an external first incoming message and outputting a wakening message and a second incoming message; and
a host apparatus for receiving the wakening message and the second incoming message to wake up the host apparatus and entering into the suspend mode after receiving the second incoming message.
